(19) United States
(12) Patent Application Publication
(10) Pub. No.: US 2013/0195531 A1
(43) Pub. Date: Aug. 1, 2013

(54) IMAGE-FORMING APPARATUS AND METHOD FOR CONTROLLING IMAGE-FORMING APPARATUS

(71) Applicant: KYOCERA DOCUMENT SOLUTIONS INC., Osaka (JP)

(72) Inventor: Satoru NAKAMURA, Osaka (JP)

(73) Assignee: KYOCERA DOCUMENT SOLUTIONS INC., Osaka (JP)

(21) Appl. No.: 13/752,898

(22) Filed: Jan. 29, 2013

(30) Foreign Application Priority Data
Jan. 31, 2012 (JP) 2012-018030

(51) Int. Cl. G03G 15/00

(52) U.S. Cl. CPC G03G 15/6502
USPC 399/388

(57) ABSTRACT

An image-forming apparatus includes an image formation unit, a resist unit, a paper feed unit, a detecting body, and a clocking unit. The resist unit stops paper conveyance before the next paper arrives. The paper feed unit includes a paper feed rotating body for rotating and thereby issuing the paper forth toward the resist unit, and for stopping before supplying the next paper. The detecting body detects the arrival of the paper. The clocking unit clocks a conveyance time from the start of paper feeding to when the detecting body detects the arrival. The resist unit starts conveying the paper when a deflection generation time has elapsed since the detection of the arrival. When the conveyance time is shorter than a predetermined reference time, the paper feed rotating body starts rotating in subsequent paper feeding at a timing that is delayed in comparison to the earlier paper feeding.

This application is based on Japanese Patent Application No. 2012-018030 filed on Jan. 31, 2012, the contents of which are hereby incorporated by reference.

### BACKGROUND

The present disclosure relates to an image-forming apparatus for printing on paper having been fed out, the image-forming apparatus including a paper feed rotating body for feeding out the paper. The present disclosure further relates to a method for controlling an image-forming apparatus for printing on paper having been fed out.

In an image-forming apparatus, paper for printing is accommodated in a cassette or the like. A rotating body for paper feeding that is in contact with the accommodated paper is made to rotate, and the paper is issued forth one sheet at a time. The paper having been issued forth is printed on while also being conveyed. In order for the paper conveyance to be properly handled, a sensor for detecting the conveyance circumstances (the position of the paper, the presence or absence of a delay, and the like) is provided to a conveyance path of the paper.

The image-forming apparatus in which the sensor is provided to the conveyance path of the paper of such description is known in the art. More specifically, there is known an image-forming apparatus comprising: a roller for pressing against the leading edge of paper to position the paper prior to image formation, during a stop, and for conveying the paper during driving; a paper sensor that is positioned immediately before the roller; a paper size designating means for designating the size of paper being used; a paper length measuring means for measuring the length of the paper on the basis of a signal from the paper sensor and of the drive start timing of the roller; a paper size mismatch detecting means for detecting a paper size mismatch when the paper length differs from the designated paper size; and a roller controlling means for stopping the driving of the roller at a timing that is set in advance with reference to the designated paper size in a case where the paper being conveyed is determined not to have a paper size mismatch, and for stopping the roller after a predetermined period of time with reference to the measured paper length in a case where the paper being conveyed is determined to have a paper size mismatch. Jamming of the paper is avoided through this configuration, even in a case where an error has been made in the setting of the paper size.

Provided to the image-forming apparatus is a resist roller pair (a resist unit), upstream in a paper conveyance direction from an image formation unit for forming an image on the paper. When the paper first arrives, the resist roller pair is stopped, and the paper strikes against the resist roller pair. The paper is thereby deflected. Because of the elasticity of the deflected paper, the leading edge of the paper runs along a nip of the resist roller pair. The resist roller pair is used in this manner to correct the skew of the paper.

The resist roller pair has also been used conventionally to adjust the paper spacing (the spacing between one sheet of paper and another) and to adjust the print speed. In the image-forming apparatus, the print speed is sometimes indicated by the number of sheets printed per minute (pages per minute (ppm)).

Conventionally, the paper spacing and/or the print speed have been adjusted by adjusting the period of time where the paper is stopped by the resist roller pair, in response to a delay in the arrival of the paper at the resist roller pair. The period of time where the paper is stopped at the resist roller pair is set to a length at which a margin is imparted. Thus, even though the arrival of the paper at the resist roller pair may be delayed from an ideal point in time, for such reasons as slipping of the rotating body that feeds out the paper, the delay is absorbed. In other words, enough of a margin for addressing a delay in the arrival of the paper is imparted to the period of time until the start of rotation of the resist roller pair. More specifically, when the arrival of the paper at the resist roller pair has been delayed, the period of time from the detection of the arrival of the paper at the resist roller pair by the sensor to when the rotation of the resist roller pair is started is reduced. This makes it possible to continue printing at a constant print speed.

Recently, there has also been an attempt to improve the print speed of the image-foaming apparatus. In order to print at high speed, there has been a narrowing of the paper spacing in comparison to the prior art. The margin in the period of time until the start of rotation of the resist roller pair aimed at addressing a delay in the arrival of the paper has also substantially disappeared. However, the period of time where the deflection of the paper is generated by the resist roller pair is needed in order to correct skew.

In view whereof, consideration has been given to starting the rotation of the resist roller pair immediately after a pause that is as long as the deflection generation period since the arrival of the paper at the resist roller pair. The paper is thereby conveyed and subjected to printing substantially without stopping. However, the paper spacing and print speed have an immediate impact on the progress or delay of paper feeding, because the paper spacing and print speed are not adjusted with the resist roller pair.

Herein, the paper is accommodated and placed in the interior of a paper cassette or the like. A rotating body that is in contact with the paper (for example, a roller or runner) rotates and feeds out the paper. The leading edge position of the paper placed therein, however, sometimes advances in front of a reference position (initial position) (i.e., sometimes deviates toward the downstream side in the paper conveyance direction). When, for example, the paper is restocked, the paper sometimes gets positioned in a state where the leading edge position of the paper has been advanced forward. Paper to be subsequently supplied may also get dragged along by the supplied paper and advanced due to friction or moisture absorption.

When the leading edge position of the paper advances in front of the reference position, the conveyance distance is shortened and the arrival of the paper at the resist roller pair is earlier. As such, the print speed increases, and a problem emerges in that the print speed is sometimes no longer stable. When printing is carried out continuously at a speed in excess of the specifications, worsening of the image quality of the printed article might take place.

The above described image-forming apparatus known in the art also relates to avoiding a paper jam when the designated size of the paper and the size of the paper actually being used differ from each other. As such, the foregoing problem cannot be resolved in the above-described image-forming apparatus known in the art.

### SUMMARY

In order to resolve the foregoing problems, an image formation device according to a first aspect of the present disclosure includes an image formation unit, a resist unit, a paper feed unit, a detecting body, and a clocking unit. The image formation unit forms an image on paper. The resist unit conveys the paper toward the image formation unit, and stops conveying paper before the next paper arrives. The paper feed unit includes a paper feed rotating body for rotating and thereby issuing the paper forth toward the resist unit, and also for stopping before supplying the next paper, and accommodates a plurality of sheets of the paper. The detecting body is provided to a paper conveyance route between the resist unit and the paper feed rotating body, and detects the arrival of the paper. The clocking unit clocks a conveyance time from the start of rotation of the paper feed rotating body to when the detecting body detects the arrival of the paper. The resist unit starts conveying the paper when a predetermined deflection generation time has elapsed since the arrival of the paper was detected by the detecting body. When the conveyance time is shorter than a predetermined reference time, the paper feed rotating body starts rotating in subsequent paper feeding at a timing that is delayed in comparison to the earlier paper feeding.

Also in order to resolve the foregoing problems, a method for controlling an image-forming apparatus according to a second aspect of the present disclosure comprises: causing an image formation unit to form an image on paper; causing a resist unit to convey the paper toward the image formation unit; causing the resist unit to stop conveying paper before the next paper arrives; accommodating a plurality of sheets of paper; causing a paper feed rotating body to rotate to issue the accommodated paper forth toward the resist unit; stopping the paper feed rotating body before the next paper is supplied; detecting the arrival of the paper on a paper conveyance route between the resist unit and the paper feed rotating body; clocking a conveyance time from the start of rotation of the paper feed rotating body to when the arrival of the paper is detected; causing the resist unit to start conveying paper when a predetermined deflection generation time has elapsed since the arrival of the paper was detected; and, when the conveyance time is shorter than a predetermined reference time, causing the paper feed rotating body to start rotating in subsequent paper feeding at a timing that is delayed in comparison to earlier paper feeding.

Further features and advantages of the present disclosure will become apparent from the description of embodiments given below.

### BRIEF DESCRIPTION OF THE DRAWINGS

FIG. 1 is a schematic cross-sectional left side view illustrating a schematic structure of a printer.

FIG. 2 is a block diagram illustrating one example of a hardware configuration of the printer.

FIG. 3 is a descriptive diagram for describing the generation of deflection in paper in the printer.

FIG. 4 is a timing chart for describing the generation of deflection in the paper.

FIG. 5 is a schematic cross-sectional view in which the vicinity of a paper feed roller of a paper feed unit has been enlarged.

FIG. 6 is a timing chart for describing an increase in the print speed due to forward advancing of the leading edge position of the paper.

FIG. 7 is a flow chart illustrating one example of a timing adjustment for the start of rotation of the paper feed roller.

### DETAILED DESCRIPTION

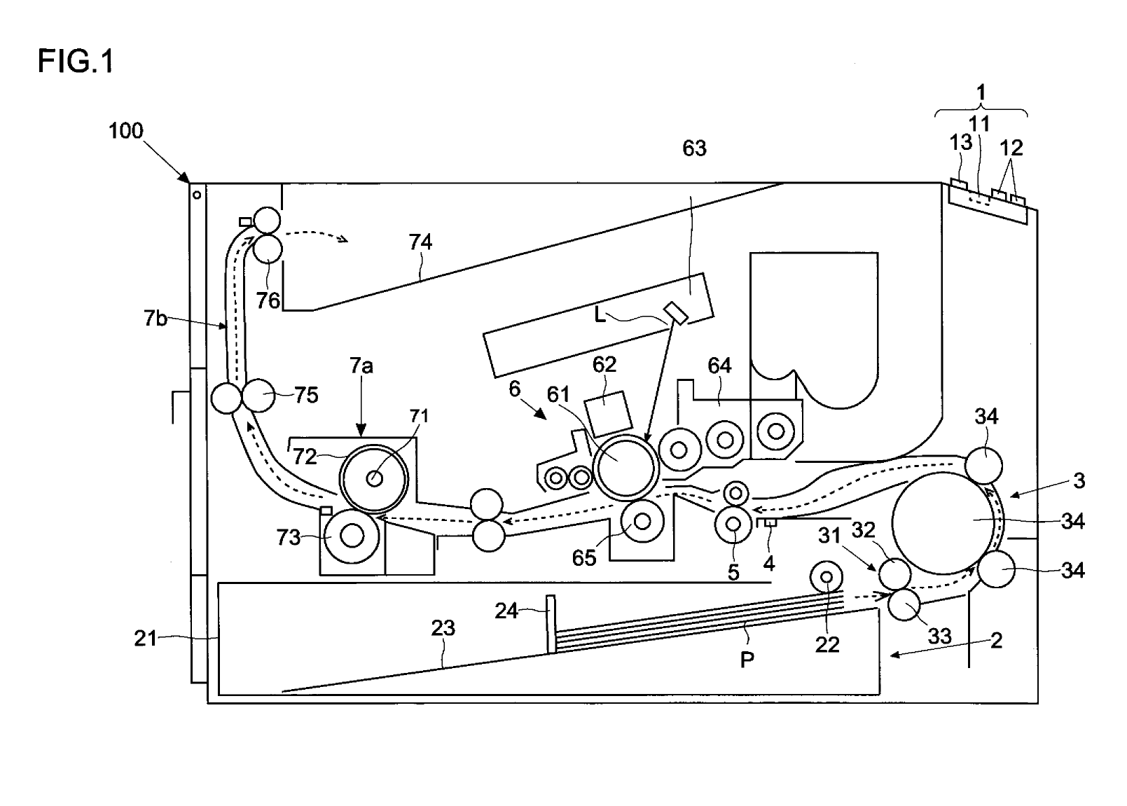

Embodiments of the present disclosure shall be described below with reference to FIGS. 1 to 7. A digital-type printer 100 in an electro-photography format is presented in the following description by way of example as an image-forming apparatus. However, the configurations, arrangements, and various other elements set forth in each of the embodiments are no more than mere descriptive examples, and in no way limit the scope of the disclosure.

(Summary of the Image-Forming Apparatus)

Firstly, a summary of the printer 100, which is an image-forming apparatus as in an embodiment, shall be described with reference to FIG. 1. FIG. 1 is a schematic cross-sectional left side view illustrating a schematic structure of the printer 100.

As illustrated in FIG. 1, an operation panel 1 is provided to the front side of the printer 100. The operation panel 1 is provided with a liquid crystal display unit 11 for displaying the status of the printer 100 and a variety of different messages. Also provided to the operation panel 1 are a key 12 for settings of various functions for the printer 100 (for example, setting the size of the paper P to be used in printing) and the like, an indicator 13 for turning a light on and off in association with the status of the printer 100 (during execution of a job, when an error occurs, and the like), and the like.

A paper feed unit 2 is also arranged below in the interior of the main body of the printer 100, as illustrated in FIG. 1. The paper feed unit 2 includes an insertable and removable cassette 21. The cassette 21 is loaded with and accommodates a plurality of sheets of the paper P. Provided to the interior of the cassette 21 is a placement plate 23, of which the downstream side in the paper conveyance direction is urged upward, and on which the paper P is placed. A rear end regulating member 24 for regulating the rear end position of the paper P is also provided to the cassette 21. The rear end regulating member 24 can be slid in accordance with the size of the paper P.

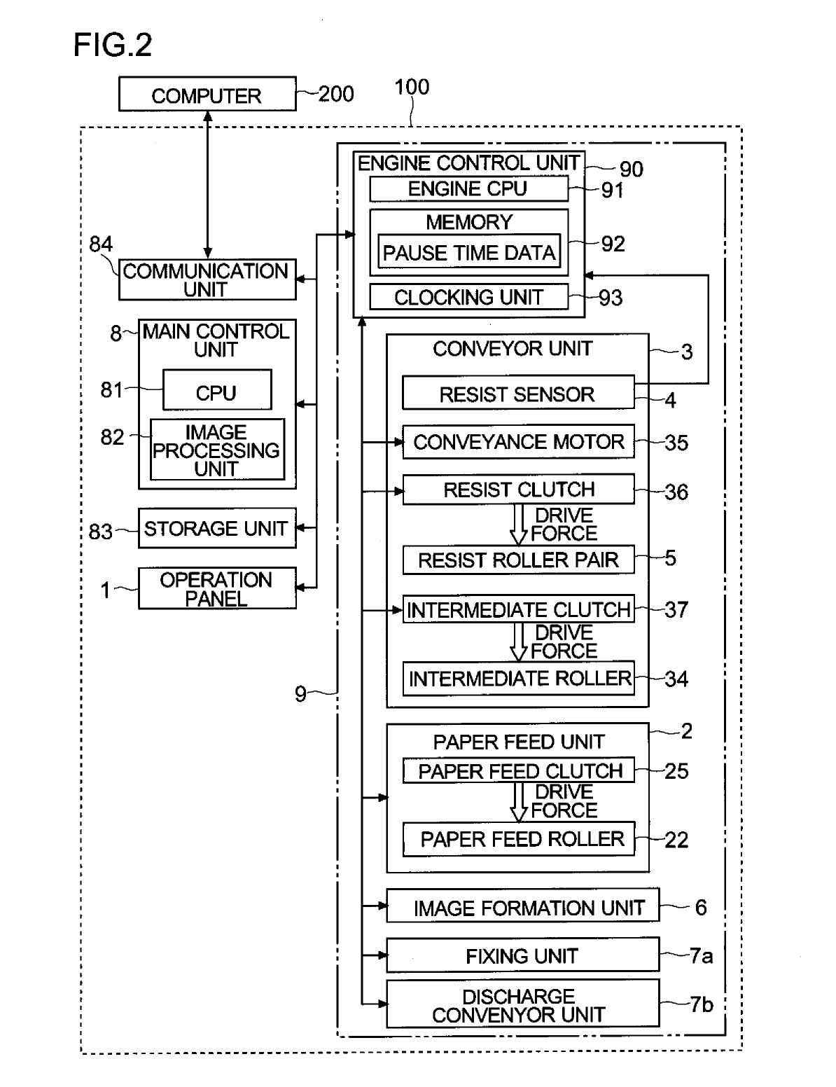

A paper feed roller 22 (equivalent to a paper feed rotating body; also sometimes called a “pick roller”) is provided to the paper feed unit 2. The paper feed roller 22 is in contact with the sheet of paper P at the uppermost position from among the sheets of paper P loaded therein. The paper feed roller 22 rotates and is driven under the drive of a conveyance motor 35 (see FIG. 2). The paper P to be used in printing is issued forth from the cassette 21 by the driving of the paper feed roller 22.

A conveyor unit 3 (paper conveyance route) is connected to the downstream side of the paper feed unit 2 in the paper conveyance direction. The conveyor unit 3 conveys the paper P supplied from the paper feed unit 2 toward an image formation unit 6. Disposed in the conveyor unit 3, from the upstream side in the paper conveyance direction, are a separating part 31, an intermediate roller pair 34, a resist sensor 4 (equivalent to a detecting body), and a resist roller pair 5 (equivalent to a resist unit).

The separating part 31 is provided in order to prevent feeding of overlapping paper (paper feeding and conveyance of two or more overlapped sheets of the paper P). The separating part 31 includes a pair of rollers. An upper feed roller 32 of the separating part 31 rotates and is driven in a direction for sending the paper P toward the image formation unit 6. A lower retard roller 33 is driven in a direction for sending overlappingly fed paper P back to the paper feed unit 2. The lower sheet(s) of paper P among the overlappingly fed paper P is/are sent back to the paper feed unit 2, and only the uppermost sheet of the paper P is conveyed toward the resist roller pair 5. Overlapping feed of the paper P is thereby eliminated. The force whereby the paper P is conveyed is stronger at the feed roller 32.

The intermediate roller pair 34 conveys the paper P toward the resist roller pair 5 and toward the image formation unit 6. The resist roller pair 5 also corrects skew of the paper P (described in greater detail below). The resist roller pair 5 waits for a predetermined deflection generation time T1 after the arrival of the paper, and thereafter starts to rotate and issue the paper P forth toward the image formation unit 6.

Provided on the downstream side of the intermediate roller pair 34 is a resist sensor 4, upstream of and in the vicinity of the resist roller pair 5. The resist sensor 4 makes it possible to detect the arrival and/or passage of the paper P at the resist roller pair 5. The resist sensor 4 can also be used (as described in greater detail below) to gauge the timing for the start of rotation of the resist roller pair 5, the timing for starting the paper feed roller 22 is started in order to feed the next sheet of paper P, and/or the timing of the start of formation of a toner image in the image formation unit 6, as will be described below.

The formation of a toner image in the image formation unit 6 shall now be described. A photosensitive drum 61 is provided to the image formation unit 6. The photosensitive drum rotates at a predetermined speed and bears the toner image. A charge unit 62 charges the photosensitive drum 61 to a constant electrical potential. An exposure unit 63 irradiates the photosensitive drum 61 with laser light L on the basis of either image data and setting data that is set during printing that are sent to the printer 100 from a computer 200 (see FIG. 2) An electrostatic latent image is thereby formed on the photosensitive drum 61. An developing device 64 supplies toner for the electrostatic latent image. The toner image is thereby developed. A transfer roller 65 (equivalent to a transfer unit) is provided below the photosensitive unit 61. The transfer roller 65 presses against the photosensitive drum 61. An electrical voltage for transfer is applied to the transfer roller 65 when the toner image and the paper P enter a nip between the transfer roller 65 and the photosensitive drum 61. The toner image is thereby transferred onto the paper P.

A fixing unit 7a is provided downstream of the image formation unit 6 in the paper conveyance direction. The fixing unit 7a applies heat and pressure to the paper P onto which the toner image has been transferred. The fixing unit 7a includes a heating roller 72 having a built-in heat generator 71, as well as a pressure roller 73 that presses against the heating roller 72 and forms a nip. The paper P bearing a toner image that has yet to be fixed is sent to the fixing unit 7a and the paper P enters the nip. Thus, the toner image is fused through the application of heat and pressure and is fixed to the paper P. The paper P upon which the image has been fixed is sent upward through a discharge conveyance path 7b, and is discharged to a discharge tray 74 at an uppermost section of the main body. Provided to the discharge conveyance path 7b are a conveyance roller pair 75 and a discharge roller pair 76 which rotate and are driven to convey the paper P toward the discharge tray 74.

(Hardware Configuration of the Printer 100)

The description shall now relate to the hardware configuration of the printer 100 as in the embodiment, on the basis of FIG. 2. FIG. 2 is a block diagram illustrating one example of the hardware configuration of the printer 100.

As illustrated in FIG. 2, the printer 100 of the present embodiment has a main control unit 8 in the interior. The main control unit 8 carries out overall control, communication control, and image processing, and controls each of the parts of the printer 100. For example, the main control unit 8 is a board that includes a CPU 81, an image processing unit 82, and the like.

The main control unit 8 is connected to a storage unit 83. The storage unit 83 is a combination of non-volatile and volatile storage devices, such as a ROM, RAM, flash ROM, HDD, and the like. The storage unit 83 stores a control program, control data, and the like for the printer 100. The CPU 81 is a central computation processing device, and carries out controls and/or computations for each of the parts of the printer 100 on the basis of setting data or the control program stored in the storage unit 83.

The image processing unit 82 is a circuit that includes an application-specific integrated circuit (ASIC), RAM for image processing, and the like. The image processing unit 82 subjects the image data to a variety of forms of image processing. The image processing unit performs enlargement, compression, density conversion, data format conversion, and other forms of image processing, in accordance with the settings. The image processing unit 82 sends the image data after image processing to the exposure unit 63. The exposure unit 63 receives the image data and carries out scanning and light exposure to form the electrostatic latent image on the photosensitive drum 61.

The main control unit 8 is connected to the operation panel 1. The main control unit 8 recognizes an input carried out at the operation panel 1. The main control unit 8 also recognizes an input entry made using the key 12. The main control unit 8 further controls the displays produced by the liquid crystal display unit 11 and the indicator 13 on the operation panel 1. For example, when a jam or other error has occurred, the main control unit 8 turns on the indicator 13 to produce a display stating that an error has occurred.

The main control unit 8 is connected to a communication unit 84. The communication unit 84 is a communication interface for communicating over a network or cable with the computer 200 (for example, a personal computer, a server, or the like) serving as a source for transmitting print data, which includes the image data for printing as well as the setting data during printing. The printer 100 prints on the basis of the image data and setting data for printing from the computer 200 having been inputted into the communication unit 84.

In order to control an engine unit 9 (portions relating to image formation, e.g., the paper feed unit 2, the conveyor unit 3, the image foliation unit 6, the fixing unit 7a, and the discharge conveyance path 7b) within the interior of the printer 100, an internal engine control unit 90 is provided.

The engine control unit 90 controls the operations of each of the parts of the engine unit 9 so that image formation is carried out properly, on the basis of a printing-related control program and control data inside a memory 92. The present embodiment describes an example where an engine control unit 90 dedicated to controlling the portions for carrying out image formation is provided separately from the main control unit 8, but the engine control unit 90 and the main control unit 8 may be integrated together, the main control unit 8 and/or the storage unit 83 then being tasked with the functions and processing of the engine control unit 90.

The engine control unit 90 is a board that includes an engine CPU 91, a memory 92, a clocking unit 93, and the like. The engine CPU 91 is a computation processing device for carrying out computations and processing on the basis of a program and/or data inside the memory 92. The memory 92 is a ROM and/or RAM for storing a program and/or data for controls relating to image formation. The clocking unit 93 clocks times relating to the controls. The clocking can also be carried out by the engine CPU 91.

The engine control unit 90 carries out such tasks as turning on or off the motors for causing the variety of rotating bodies inside the engine unit 9 to rotate, and the like, and controls the feeding and conveyance of the paper P. The engine control unit 90 also controls the toner image formation in the image formation unit 6, controls the affixation temperature in the fixing unit 7a, and so forth. The engine control unit 90 thus governs controls relating to printing.

With respect to paper feeding and paper conveyance, for example, a conveyance motor 35, a resist clutch 36, and an intermediate clutch 37 also are provided, in addition to the above-described resist sensor 4, to the conveyor unit 3, as illustrated in FIG. 2. A paper feed clutch 25 is also provided to the paper feed unit 2, for the paper feed roller 22.

For example, the resist sensor 4 is an optical sensor. For the resist sensor 4, it would be possible to use a reflection-type optical sensor provided with a light-emitting unit for irradiating the conveyor unit 3 with light and a light-receiving unit for receiving the light reflected by the paper P. It would further be possible to use as the optical sensor a transmission-type optical sensor provided with a light-emitting unit, a light-receiving unit, and an actuator for moving in contact with the paper P being conveyed. It is possible to use a transmission-type optical sensor such as one where the output changes, with the actuator blocking the light from the light-emitting unit to the light-receiving unit when the paper P is not arriving and passing through, and with the actuator changing position when the paper P is arriving and passing through to allow the light to arrive at the light-receiving unit from the light-emitting unit. Provided the resist sensor is able to detect the arrival and/or passage of the paper P, there is no limitation to the sensor being an optical sensor; a variety of other sensors may also be used.

The output (outputted voltage value) is switched between when the resist sensor 4 is able to and is not able to detect the presence of the paper P. The output of the resist sensor 4 is inputted to the engine control unit 90. The engine control unit 90 is able to recognize that the paper P has arrived at the position at which each sensor is installed (the position of the resist roller pair 5), or that the paper P is passing therethrough or is not present, or that the paper P having arrived has passed through, depending on the output of the resist sensor 4, such as an output of High or Low, or a switch from High to Low or from Low to High.

The conveyance motor 35 is a drive source for causing the resist roller pair 5, the intermediate roller pair 34, and the paper feed roller 22 to rotate. A plurality of gears (not shown) are connected to the conveyance motor 35, and the drive force is transmitted to the resist roller pair 5, the intermediate roller pair 34, the paper feed roller 22, and the separating part 31. A plurality of motors for feeding paper and for conveying, such as for paper feeding or for conveyance in the conveyor unit 3, may also be provided. The engine control unit 90 causes the conveyance motor 35 to rotate so that the resist roller pair 5, the intermediate roller pair 34, and the paper feed roller 22 rotate at predetermined speeds.

The resist clutch 36 is for controlling the rotation of the resist roller pair 5. The resist clutch 36 is provided to a transmission route for transmitting the drive force from the conveyance motor 35. For example, the resist clutch 36 is an electromagnet-type clutch. The resist clutch 36 adopts a linked state or released state in accordance with a signal from the engine control unit 90. The engine control unit 90 turns on or off the transmission of the drive force from the conveyance motor 35 to the resist roller pair 5, and controls the rotation of the resist roller pair 5.

When causing the resist roller pair 5 to rotate, the engine control unit 90 places the resist clutch 36 in the linked state while also causing the conveyance motor 35 to rotate. The resist roller pair 5 is thereby made to rotate. However, when causing the resist roller pair 5 to stop, the engine control unit 90 either causes the conveyance motor 35 to stop or places the resist clutch 36 in the released state. The resist roller pair 5 is thereby kept in a stopped state.

The intermediate clutch 37 is adapted for controlling the rotation of the intermediate roller pair 34. The intermediate clutch 37 is provided to a transmission route for transmitting the drive force from the conveyance motor 35. For example, the intermediate clutch 37 is also an electromagnet-type clutch. The intermediate clutch 37 adopts a linked state or released state in accordance with a signal from the engine control unit 90. The engine control unit 90 thereby turns on or off the transmission of the drive force from the conveyance motor 35 to the intermediate roller pair 34, and controls the rotation of the intermediate roller pair 34.

When causing the intermediate roller pair 34 to rotate, the engine control unit 90 places the intermediate clutch 37 in the linked state while also causing the conveyance motor 35 to rotate. The intermediate roller pair 34 is thereby made to rotate. However, when causing the intermediate roller pair 34 to stop, the engine control unit 90 either causes the conveyance motor 35 to stop, or places the intermediate clutch 37 in the released state. The intermediate roller pair 34 is thereby stopped. The intermediate clutch 37 also need not be provided, with the intermediate roller pair 34 then being continuously made to rotate during printing (during rotation of the conveyance motor 35).

A clutch for turning the drive on or off may also be provided for each of the rollers of the separating part 31.

The paper feed clutch 25 is for controlling the rotation of the paper feed roller 22. The paper feed clutch 25 is provided to a transmission route for transmitting the drive force from the conveyance motor 35. For example, the paper feed clutch 25 is an electromagnet-type clutch. The paper feed clutch 25 adopts a linked state or a released state in accordance with a signal from the engine control unit 90. The engine control unit 90 thereby turns on or off the transmission of the drive force from the conveyance motor 35 to the paper feed roller 22, and controls the rotation of the paper feed roller 22.

When causing the paper feed roller 22 to rotate, the engine control unit 90 places the paper feed clutch 25 in the linked state while also causing the conveyance motor 35 to rotate. The paper feed roller 22 is thereby made to rotate. However, when causing the paper feed roller 22 to stop, the engine control unit 90 either causes the conveyance motor 35 to stop, or places the paper feed clutch 25 in the released state. The paper feed roller 22 is thereby stopped.

(Generation of Deflection in the Paper P)

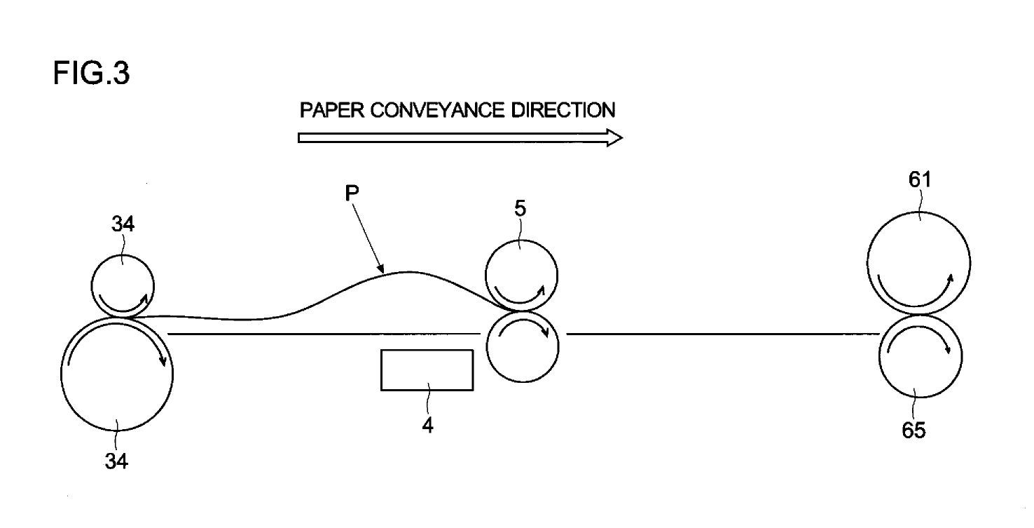

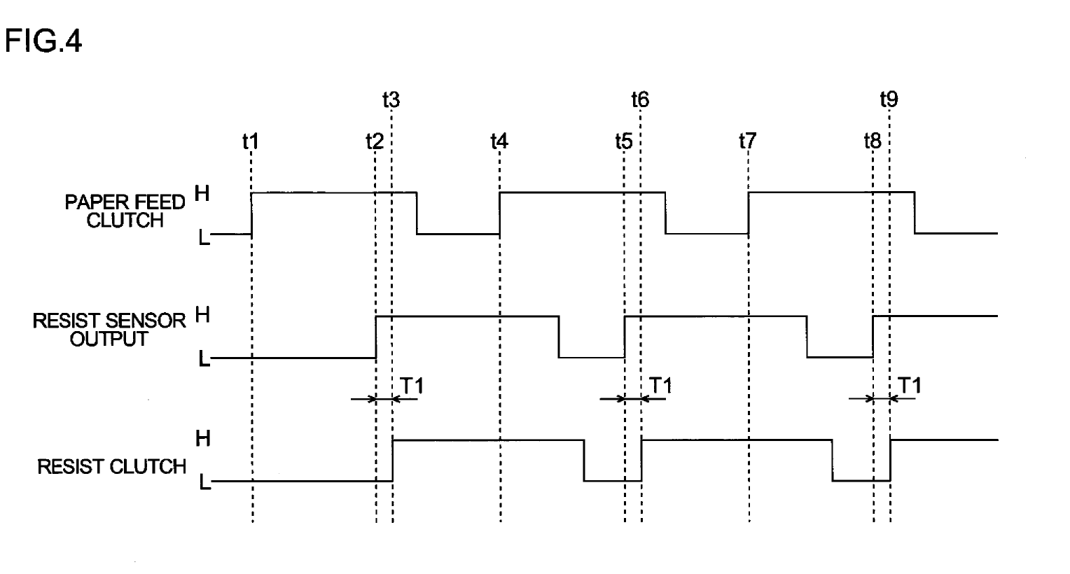

The description shall now relate to the generation of deflection in the paper P in the printer 100 as in the embodiment, with reference to FIGS. 3 and 4. FIG. 3 is a descriptive diagram for describing the generation of deflection in paper P in the printer 100. FIG. 4 is a timing chart for describing the generation of deflection in the paper P.

FIG. 3 is a diagram schematically illustrating the paper conveyance route, from the intermediate roller pair 34 until the image formation unit 6. More specifically, FIG. 3 illustrates the intermediate roller pair 34, the resist sensor 4, the resist roller pair 5, and the photosensitive drum 61 and transfer roller 65 of the image formation unit 6, in the stated order from the left. For the sake of convenience, FIG. 3 illustrates the paper conveyance route on a straight line, with the vertical positions of the intermediate roller 34, the resist roller pair 5, and the image formation unit 6 being substantially the same position. Also, the illustration in FIG. 3 has substantially identical distances for the distance between the intermediate roller pair 34 and the resist roller pair 5 and the distance between the resist roller pair 5 and the image formation unit 6, for the sake of convenience.

In the printer 100 of the present embodiment, the engine control unit 90 causes the paper to be conveyed to the intermediate roller 34 and causes the paper to be deflected while also striking the paper P against the resist roller pair 5 (see FIG. 3). The elasticity of the deflected paper P causes the paper P to run along the nip of the resist roller pair 5 and corrects for skew.

In view whereof, the description shall now relate to the operation of the resist roller pair 5 and the generation of deflection, with reference to FIG. 4. FIG. 4 is a timing chart of when printing is being carried out in a continuous manner on a plurality of sheets of the paper P. The length of the time for causing the paper feed roller 22 to rotate, the length of the time for causing the resist roller pair 5 to rotate, the time where the resist sensor 4 detects the paper P, and the time from the start of paper feeding to when the resist sensor 4 detects the paper P all vary depending on the size of the paper P, the conveyance speed, the conveyance distances, and the like, and the timing chart in FIG. 4 is one example.

Firstly, the uppermost chart in FIG. 4 (the chart labeled “PAPER FEED CLUTCH”) illustrates the linking and releasing of the paper feed clutch 25. The state where the engine control unit 90 links the paper feed clutch 25 and causes the paper feed roller 22 to rotate is illustrated as “High.” The state where the engine control unit 90 releases the paper feed clutch 25 and causes the paper feed roller 22 to stop is illustrated as “Low.” In FIG. 4, the engine control unit 90 places the paper feed clutch 25 in the linked state at the points in time t1, t4, and t7. In other words, t1, t4, and t7 are points in time for starting the paper feed.

The engine control unit 90 causes the intermediate roller pair 34 to rotate and causes the paper P supplied from the paper feed unit 2 to be conveyed toward the resist roller pair 5. The engine control unit 90 turns off the paper feed clutch 25 and stops the rotation of the paper feed roller 22 prior to the start of feeding of the next sheet of paper P.

Next, the second chart from the top of FIG. 4 (the chart labeled “RESIST SENSOR OUTPUT”) illustrates one example of the changes in output of the resist sensor 4. In the present description, the resist sensor 4 outputs “High” when detecting the presence of the paper P, and outputs “Low” when not detecting the presence of the paper P. In FIG. 4, at the points in time t2, t5, and the engine control unit 90 recognizes that the paper P has arrived at the resist sensor 4 on the basis of the output of the resist sensor 4. For example, the engine control unit 90 gauges the timing of the start of toner image formation in accordance with the detection of the arrival of the paper by the resist sensor 4.

The lowermost chart in FIG. 4 (the chart labeled “RESIST CLUTCH”) illustrates the linking and release of the resist clutch 36. The state where the engine control unit 90 links the resist clutch 36 and causes the resist roller pair 5 to rotate is illustrated as “High.” The state where the engine control unit 90 releases the resist clutch 36 and causes the resist roller pair 5 to stop is illustrated as “Low.” In FIG. 4, the engine control unit 90 places the resist clutch 36 in the linked state at the points in time t3, t6, t9. In other words, the points in time t3, t6, t9 are points in time for secondary starting of the paper feed by the resist roller pair 5.

As illustrated in the lowermost chart in FIG. 4, the engine control unit 90 has placed the resist roller pair 5 in a stopped state when the paper P has arrived at the resist sensor 4. The engine control unit 90 causes the intermediate roller pair 34 to continue conveying the paper while the resist roller pair 5 remains stopped. As a result, the leading edge of the paper P strikes against the resist roller pair 5, and the paper P is deflected.

As illustrated in FIG. 4, the engine control unit 90 turns the resist clutch 36 on and causes the resist roller pair 5 to start rotating after a wait that is as long as a predetermined deflection generation time T1 (when the deflection generation time T1 has elapsed) since the detection of the arrival of the paper by the resist sensor 4. More specifically, the periods of time between t2 and t3, between t5 and t6, and between t8 and t9 in FIG. 4 are the deflection generation time T1. The engine control unit 90 causes the resist roller pair 5 to rotate, and causes the paper P to be conveyed toward the nip of the transfer roller 65 and the photosensitive drum 61. Prior to the arrival of the subsequent sheet of paper P, the engine control unit 90 turns the resist clutch 36 off and stops the rotation of the resist roller pair 5.

The intermediate roller pair 34 may continue rotating (there is no need for the intermediate roller pair 34 to be stopped) until one print job (printing of a plurality of sheets) is complete, unless there is an outstanding reason such as the occurrence of an error.

(Leading Edge Position of the Paper P)

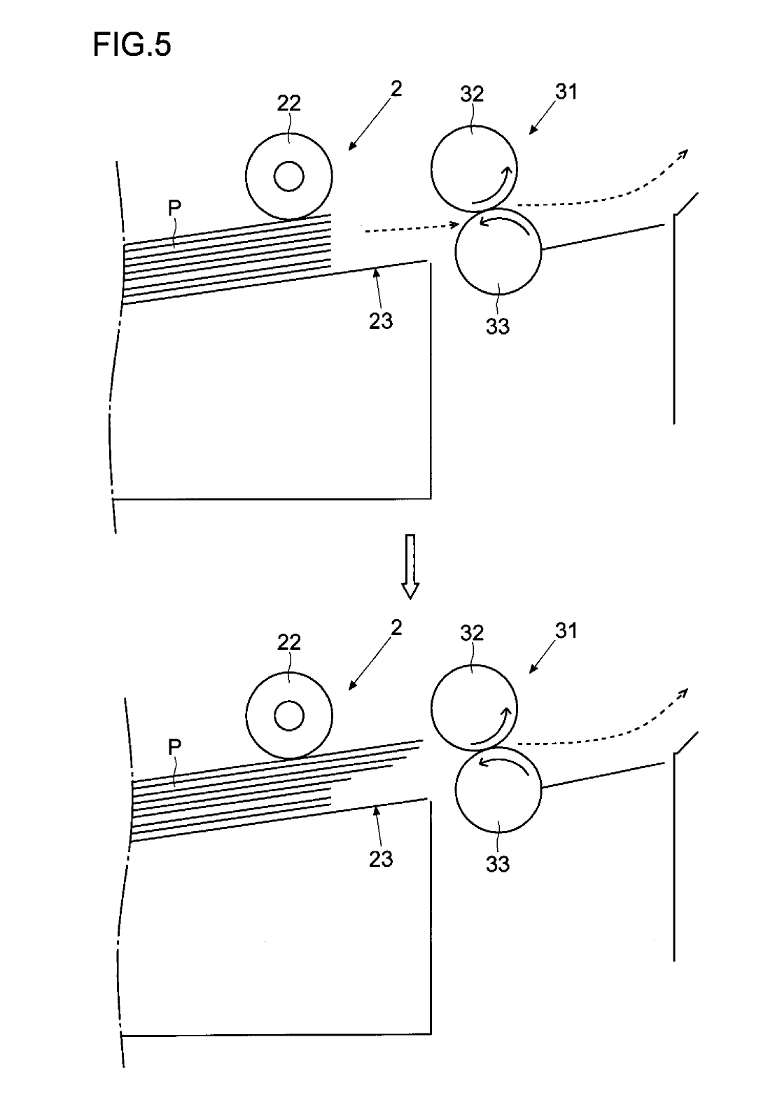

The description shall now relate to deviation of the leading edge position of the paper P, with reference to FIGS. 1 and 5. FIG. 5 is a schematic cross-sectional view in which the vicinity of the paper feed roller 22 of the paper feed unit 2 has been enlarged.

As illustrated in FIG. 1, the placement plate 23, on which the paper P is placed, and the rear end regulating member 24 are provided to the paper feed unit 2. The paper P is set upon the placement plate 23 in accordance with the position of the rear end regulating member 24. The paper P cannot be placed upstream of the rear end regulating member in the paper conveyance direction. As such, the paper position in the state where the rear end side of the paper P is regulated by the rear end regulating member 24 (the state of contact therebetween) serves as a reference position for the accommodated paper P. When the paper P is placed at the reference position, for example, the leading edge position of the paper P is located below (immediately below) the paper feed roller 22. The top of FIG. 5 illustrates the state where the paper P is at the reference position.

However, in some cases the leading edge position of the paper P advances to the downstream side in the paper conveyance direction (toward the separating part 31). For example, when the paper P is being restocked, a paper bundle is sometimes set in the cassette 21 in a state where the leading edge position has deviated forward, whereby the leading edge position of the paper P advances forward.

Also, dragged by the issuing forth (supplying) of the sheet of paper P at the uppermost position during paper feeding, the sheet of paper P below the uppermost position sometimes also advances forward. For example, a coarser surface of the paper correlates to a greater force of friction between the sheets of paper, which in turn correlates to a sheet of paper P being more likely to be dragged by the sheet of paper P being fed and thus more likely to advance forward. Moistening of the paper P strengthens the adsorption force between sheets of paper, and a sheet of paper P is then sometimes dragged by the sheet of paper P being fed and thus more likely to advance forward (this is especially true of paper having a resin-coated surface). The leading edge position of the paper P that is returned by the separating part 31 because of overlapping feeding of the paper P also is in a state of having been advanced forward.

Forward advancing of the leading edge position of the paper P accommodated by the paper feed unit 2 thus takes place due to various different factors. The bottom of FIG. 5 illustrates one example of a state where the paper P has advanced forward. As illustrated in FIG. 5, it is possible for there to be a state where a plurality of sheets of the paper P have advanced forward.

(Increase in the Print Speed Due to Forward Advancing of the Leading Edge Position of the Paper P)

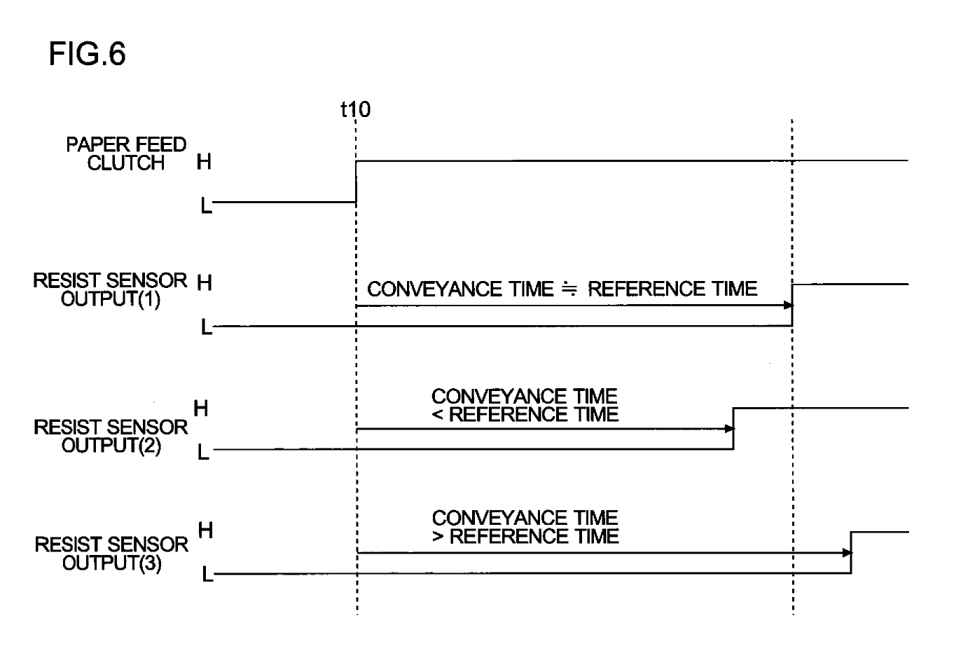

The description shall now relate to the increase in the print speed due to the forward advancing of the leading edge position of the paper P, with reference to FIG. 6. FIG. 6 is a timing chart for describing the increase in the print speed due to forward advancing of the leading edge position of the paper P.

Firstly, the uppermost chart in FIG. 6 illustrates the linking and release of the paper feed clutch 25. As such, “High” illustrates rotation of the paper feed roller 22 (linking of the paper feed clutch 25), while “Low” illustrates stopping of the paper feed roller 22 (release of the paper feed clutch 25). In FIG. 6, the point in time t10 is a point in time at which paper feeding starts.

Next, the chart labeled “RESIST SENSOR OUTPUT (1)” in FIG. 6 (the second chart from the top) illustrates one example of the changes in output of the resist sensor 4 when the position of the paper P in the paper feed unit 2 is at the reference position. In the present description, the resist sensor 4 outputs “High” when detecting the presence of the paper P, and outputs “Low” when not detecting the presence of the paper P (the same applies hereinbelow).

From the standpoint of checking for whether the print speed given in the specifications is being maintained, the clocking unit 93 of the engine control unit 90 measures the time from the start of rotation of the paper feed roller 22 (from the turning on of the paper feed clutch 25) to when the resist sensor 4 detects the leading edge of the paper P (hereinafter, the “conveyance time”).

A reference time is also established, as an ideal conveyance time. For example, the storage unit 83, the memory 92 of the engine control unit 90, or the like stores data indicative of the reference time.

The reference time is the time (ideal time) from after paper feeding is started in the state where the paper P is at the reference position, to when the resist sensor 4 detects the arrival of the paper P. In other words, in keeping the print speed (ppm) at a reference speed, the reference time is a time from the start of proper paper feeding to when the detecting body detects the arrival of the paper. For example, the reference time can be found by dividing the conveyance distance from the leading edge position of the paper P at the reference position until the resistance sensor 4 by a paper conveyance speed that is predetermined in the specifications. The reference time may also be established empirically, such as by gauging the conveyance time through experimentation or the like and taking the average thereof.

When the leading edge position of the paper P is at the reference position and the paper P is conveyed in an ideal fashion, the measured conveyance time will be either the same or substantially the same as the reference time, as illustrated in the chart “RESIST SENSOR OUTPUT (1)” in FIG. 6.

The chart labeled “RESIST SENSOR OUTPUT (2)” in FIG. 6 (the second chart from the top) illustrates one example of the changes in output of the resist sensor 4 when the position of the paper P in the paper feed unit 2 has advanced forward.

When the leading edge position of the paper P has advanced forward, the conveyance distance is shorter, and thus, as illustrated in the chart “RESIST SENSOR OUTPUT (2)”, the measured conveyance time is shorter than the reference time.

In the printer 100 of the present embodiment, when paper is being fed in a continuous fashion, the timing for starting the feeding of the next sheet of paper is gauged from the arrival of the paper at the resist sensor 4, or alternatively from the start of rotation of the resist roller pair 5. In other words, the paper feed roller 22 begins rotating and the next sheet of paper P is fed when a pause time has elapsed since the arrival of the paper at the resist sensor 4, or alternatively since the start of rotation of the resist roller pair 5.

There is little impact on the print speed when there is only one sheet of the paper P of which the leading edge position has advanced forward. However, the interval between sheets of paper is smaller when a plurality of sheets of the paper P are being supplied in a continuous fashion from an advanced position. For this reason, there is an increase in the number of cycles per unit time where the resist roller pair 5 begins rotation. As such, a state where the print speed given in the specifications is exceeded persists when a plurality of sheets of the paper P are supplied in a continuous fashion from an advanced position.

In a persistent state where the print speed is faster than what is given in the specifications, a greater amount of toner is consumed and toner that has not been fully charged is more likely to be used for development. As such, poor transfer may take place, and the density of the toner image may be lighter than the original density. Also, in a persistent state where the print speed is higher than what is given in the specifications, in some cases the temperature elevation imparted by the heater (the heat generator 71) will be unable to keep up with the decline in temperature of the fixing unit 7a, and it becomes difficult to maintain the temperature needed for fixing. As such, poor fixing may also take place, and the result may be that toner remains on the printed article without being fixed thereto.

The description shall now raise a specific example. For example, the printer 100 of the present embodiment is enabled, as per the specifications, to print 60 sheets of paper every minute (60 ppm). The distance from the leading edge of the paper P at the reference position until the separating part 31 is about 20 to 30 mm. In the event that the leading edge position of the paper P has advanced forward, the conveyance distance from the paper feed unit 2 until the resist roller pair 5 will be shorter than the ideal distance. As such, when printing is continued in the state where the leading edge position of the paper P is advanced forward, the print speed of the printer 100 of the present embodiment might increase by about 3 to 4 ppm (reaching 63 to 64 ppm). When this state where the print speed is higher than what is given in the specifications persists, poor transfer and poor affixation might take place.

In view whereof, the engine control unit 90 of the present embodiment compares the conveyance time and the reference time. The engine control unit 90 recognizes whether or not the leading edge position of the paper P inside the paper feed unit 2 has advanced forward. Upon recognizing that the leading edge of the paper P has advanced forward, the engine control unit 90 delays the timing for the start of paper feeding, in order to lower the print speed.

The chart labeled “RESIST SENSOR OUTPUT (3)” in FIG. 6 (the lowermost chart) illustrates one example of the changes in output of the resist sensor 4 when the conveyance time is longer than the reference time and there is a delay in paper feeding.

In, for example, a case where the paper P is more prone to slip, a case where the paper feed roller 22 has abraded, a case where foreign matter has stuck onto the paper feed roller 22, or the like, slipping of the paper feed roller 22 might cause the paper feeding to be delayed. When paper feeding is delayed, the print speed of the printer 100 will not meet the specifications. In view whereof, when a delay in paper feeding causes the print speed to be lower, the engine control unit 90 expedites the timing for the start of rotation of the paper feed roller 22.

(Flow for Adjusting the Timing for the Start of Rotation of the Paper Feed Roller 22)

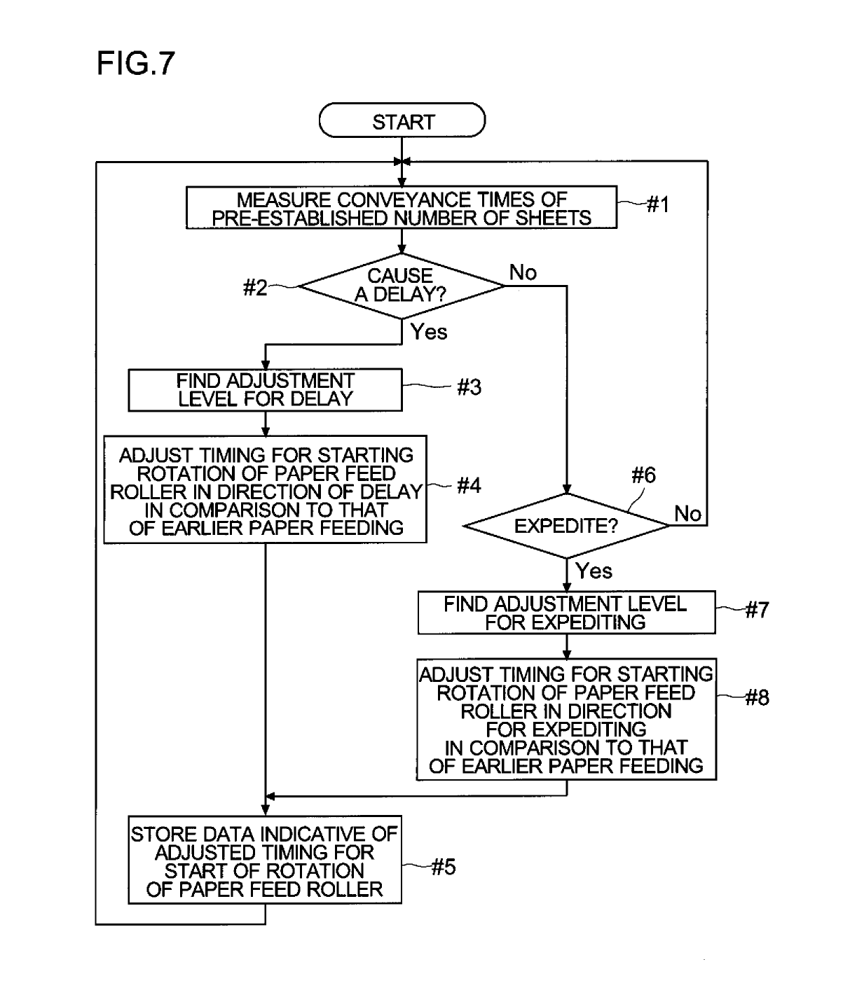

The description shall now relate to one example of timing adjustment for the start of rotation of the paper feed roller 22, with reference to FIG. 7. FIG. 7 is a flow chart illustrating one example of the timing adjustment for the start of rotation of the paper feed roller 22.

For example, the START in FIG. 7 is a point in time where a main power source of the printer 100 is turned on. The engine control unit 90 then measures the time from the start of rotation of the paper feed roller 22 (the linking of the paper feed clutch 25) until the detection of the arrival of the paper by the resist sensor 4, every time paper feeding is carried out during printing. The engine control unit 90 then measures the conveyance time for a predetermined number of sheets (step #1).

The predetermined number of sheets can be established as desired, being a number of sheets adapted for recognition of whether or not a plurality of sheets of the paper P have advanced forward together (in a paper bundle). However, when a large number is set for the predetermined number of sheets (for example, when the setting is for 11 sheets or more), the period for adjusting the timing of the start of rotation of the paper feed roller 22 is longer. In so doing, there is the possibility that the point in time for adjusting the timing of the start of rotation may no longer be appropriate. In view whereof, the predetermined number of sheets shall be about 2 to 10 sheets, more preferably about 2 to 3 sheets in the printer 100 of the present embodiment. This allows for a period of a comparatively smaller number of sheets.

The engine control unit 90 then checks for whether or not the timing for starting the rotation of the paper feed roller 22 should be delayed (step #2). For example, the engine control unit 90 may determine to delay the timing for starting the rotation of the paper feed roller 22 when any one conveyance time from among the conveyance times of the predetermined number of sheets is shorter than the reference time. Alternatively, the engine control unit 90 may determine to delay the timing for starting the rotation of the paper feed roller 22 when the average value for the conveyance times of the predetermined number of sheets is shorter than the reference time.

So as not to delay the timing for starting the rotation of the paper feed roller 22 even if, unexpectedly, only one sheet of the paper P has arrived early at the resist roller pair 5, the engine control unit 90 may determine to delay the timing for starting the rotation of the paper feed roller 22 when the conveyance speed is shorter than the reference time with the predetermined number of sheets sent in a continuous fashion.

When delaying the timing for starting the rotation of the paper feed roller 22 (“Yes” in step #2), the engine control unit 90 establishes a level (adjustment level) by which to delay the rotation of the paper feed roller 22 (step #3). More specifically, the engine control unit 90 may establish as the adjustment level the absolute value of the time difference between the reference time and any one of the conveyance times from among the conveyance times of the predetermined number of sheets. Alternatively, the engine control unit 90 may establish as the adjustment level the absolute value of the time difference between the reference time and the average value of the conveyance times of the predetermined number of sheets.

The engine control unit 90 then makes an adjustment in the direction that delays the timing for starting the rotation of the paper feed roller 22, on the basis of the adjustment level thus found (step #4). Thus, in subsequent paper feeding, the paper feed roller 22 starts rotating at a timing that is delayed in comparison to the earlier paper feeding when the conveyance time is shorter than the predetermined reference time (when there is the progress in paper feeding and/or paper conveyance).

More specifically, in the printer 100 of the present embodiment, the engine control unit 90 starts the rotation of the paper feed roller 22 after a pause time has elapsed since the arrival of the paper P was detected by the resist sensor 4, or since the resist roller pair 5 started conveying the paper P. In view whereof, the engine control unit 90 delays the timing for starting the rotation of the paper feed roller 22 by lengthening the pause time.

In other words, in a case where an adjustment for delaying the timing for the start of paper feeding is not carried out, the point in time for the engine control unit 90 to start paper feeding (the timing for starting the rotation of the paper feed roller 22) is a point in time where the same pause time as from the earlier paper feeding has elapsed since the arrival of the paper P was detected by the resist sensor 4, or since the resist roller pair 5 started conveying the paper P. In view whereof, when delaying the timing for the start of paper feeding, the engine control unit 90 causes the pause time to be longer than that of the earlier paper feeding. During the next paper feeding, the engine control unit 90 starts the rotation of the paper feed roller 22 at a timing for the start of rotation that has been adjusted so that the point in time for starting the next feeding of the paper is delayed in comparison to the point in time for starting paper feeding in a case where the setting is the same as that of the earlier paper feeding.

The engine control unit 90 then prepares for the next timing for the start of rotation of the paper feed roller 22, and stores in the memory 92 data indicative of the adjusted timing for the start of rotation of the paper feed roller 22 (step #5). For example, data indicative of the length of the adjusted pause time is stored as the data indicative of the adjusted timing for the start of rotation of the paper feed roller 22. Following step #5, the flow returns to step 41.

However, when the timing for starting the rotation of the paper feed roller 22 is not to be delayed (“No” in step #2), the engine control unit 90 then checks for whether or not the timing for starting the rotation of the paper feed roller 22 should be expedited (step #6).

When paper feeding and/or paper conveyance are being carried out in a substantially ideal fashion, there should be no change in the timing for starting the rotation of the paper feed roller 22. In view whereof, when any one conveyance time among the conveyance times of the predetermined number of sheets is the same or substantially the same as the reference time (when the difference between any one of the conveyance times and the reference time falls within a predetermined acceptable range), the engine control unit 90 may determine there to be no need to expedite the timing for starting the rotation of the paper feed roller 22. Alternatively, when the average value of the conveyance times of the predetermined number of sheets is the same or substantially the same as the reference time (when the difference between the average value of the conveyance times and the reference time falls within a predetermined acceptable range), the engine control unit 90 may determine there to be no need to expedite the timing for starting the rotation of the paper feed roller 22.

When there is no need to expedite (“No” in step #6), the flow returns to step #1. However, when there is a need to expedite (“Yes” in step #6), the engine control unit 90 establishes a level (adjustment level) by which to expedite the rotation of the paper feed roller 22 (step #7). More specifically, the engine control unit 90 may establish as the adjustment level the absolute value of the time difference between the reference time and any one conveyance time among the conveyance times of the predetermined number of sheets, or the absolute value of the time difference between the reference time and the average value of the conveyance times and the predetermined number of sheets.

Then, the engine control unit 90 makes an adjustment in a direction that expedites the timing for starting the rotation of the paper feed roller 22, on the basis of the adjustment level thus found (step #8). Thus, in subsequent paper feeding, the paper feed roller 22 starts rotating at a timing that is expedited in comparison to the earlier paper feeding when the conveyance time is longer than the predetermined reference time (when there is the delay in paper feeding and/or paper conveyance).

More specifically, the engine control unit 90 expedites the timing for starting the rotation of the paper feed roller 22 by shortening the above-described pause time by an amount commensurate with the absolute value of the time difference. The flow then transitions to step #5.

In other words, in a case where an adjustment for expediting the timing for the start of paper feeding is not carried out, the point in time that the engine control unit 90 starts paper feeding (the timing for starting the rotation of the paper feed roller 22) is a point in time where the same pause time as from the earlier paper feeding has elapsed since the arrival of the paper P was detected by the resist sensor 4, or since the resist roller pair 5 started conveying the paper P. In view whereof, when expediting the timing for the start of paper feeding, the engine control unit 90 causes the pause time to be shorter than that of the earlier paper feeding. During the next paper feeding, the engine control unit 90 starts the rotation of the paper feed roller 22 at a timing for the start of rotation that has been adjusted so that the point in time for starting the next feeding of the paper is expedited in comparison to the point in time for starting paper feeding in a case where the setting is the same as that of the earlier paper feeding.

Data indicative of the timing for the start of rotation of the paper feed roller 22 (data indicative of the above-described pause time) is stored in the memory 92. A pause time that serves as a reference may have been predetermined and may then be stored in the memory 92. When the conveyance time is the same or substantially the same as the reference time, the pause time serving as a predetermined reference is established so that the print speed given in the specifications (the predetermined number of sheets printed per unit time) is reached. When a predetermined condition, such as the printing of a predetermined number of sheets, turning on of the power source of the printer 100, or the insertion or removal of the cassette 21, is fulfilled, the engine control unit 90 may reset the data indicative of the adjusted timing for the start of rotation of the paper feed roller 22 in the memory 92 (the data indicative of the adjusted pause time), and return the timing for the start of rotation of the paper feed roller 22 (the pause time) to the reference. This makes it possible to avoid continuing to make adjustments for causing the timing for starting the rotation of the paper feed roller 22 to deviate from the reference despite the fact that there has been a change in the status of the paper, such as when the paper is set so as to be correct.

Thus, the image formation device (printer 100) as in the present disclosure includes: the image formation unit 6 for forming an image on the paper P; the resist unit (resist roller pair 5) for conveying the paper P toward the image formation unit 6; the paper feed unit 2 for accommodating a plurality of sheets of the paper P, the paper feed unit 2 for accommodating a plurality of sheets of the paper P, the paper feed unit including the paper feed rotating body (the paper feed roller 22) for rotating and thereby issuing the paper P forth toward the resist unit, and also for stopping before supplying the next sheet of paper P; the detecting body (the resist sensor 4) for detecting the arrival of the paper, the detecting body being provided to the paper conveyance route between the resist unit and the paper feed rotating body; and the clocking unit 93 for clocking the conveyance time from the start of rotation of the paper feed rotating body to when the detecting body detects the arrival of the paper. The resist unit starts paper conveyance when the predetermined deflection generation time T1 has elapsed since the arrival of the paper was detected by the detecting body, and stops paper conveyance before the next sheet of paper arrives at the resist unit. When the conveyance time is shorter than the predetermined reference time, the paper feed rotating body starts rotating in subsequent paper feeding at a timing that is delayed in comparison to the earlier paper feeding.

This makes it possible to delay the arrival of the paper P at the resist unit, even when the leading edge position of the paper P accommodated in the paper feed unit 2 has advanced forward, when the stop time of the paper P for stopping the paper P by an amount commensurate with the time needed to generate deflection (for skew correction) for the resist unit (the resist roller pair 5) has been minimized. As such, it is possible to prevent an increase in the print speed and to stabilize the print speed at a reference speed (the predetermined speed given in the specifications) even in a state where the leading edge position of the paper P has advanced forward and the paper conveyance distance from the paper feed unit 2 to the resist unit is shorter. It is also possible to prevent a decline in image quality in the printed article caused by the print speed being faster than that given in the specifications.

The paper feed rotating body (the paper feed roller 22) starts rotating after the pause time has elapsed since the arrival of the paper P was detected by the detecting body (the resist sensor 4) or since the resist unit (the resist roller pair 5) started conveying the paper P, and, by causing the pause time to be longer than that of the earlier print feeding, starts rotating at a timing that is delayed in comparison to that of the earlier paper feeding. A timing for when the rotation of the paper feed rotating body (the paper feed roller 22) should be started, so that the print speed is stably at the reference speed (the speed given in the specifications), is thereby adopted.

The paper feed rotating body (the paper feed roller 22) starts rotating at a timing that is delayed in comparison to that of the earlier paper feeding by an amount commensurate with the absolute value of the time difference between the reference time and any one conveyance time among the conveyance times of the predetermined number of sheets, or with the absolute value of the time difference between the reference time and the average value of the conveyance times of the predetermined number of sheets. This makes it possible to lower the print speed so as to return to the reference speed even though the leading edge positions of a plurality of sheets of the paper P have advanced forward together and the print speed has become faster.

The paper feed rotating body (the paper feed roller 22) starts rotating at a timing that is delayed in comparison to the earlier paper feeding when any one conveyance time among the conveyance times of the predetermined number of sheets or the average value of the conveyance times of the predetermined number of sheets is shorter than the reference time. This makes it possible to lower the print speed when there is a high likelihood that the leading edge position of the paper P has advanced forward.

The paper feed rotating body (the paper feed roller 22) starts rotating in subsequent paper feeding at a timing that is delayed in comparison to the earlier paper feeding when the conveyance time is shorter than the reference time in a continuous fashion lasting as long as the predetermined number of sheets. This makes it possible to delay the timing for the start of rotation of the paper feed rotating body (the paper feed roller 22) and to lower the print speed when the leading edge positions of a plurality of sheets of the paper P are deemed to have advanced forward together (a bundle of the paper P, as a unit).

A tendency for paper feeding (issuing forth of the paper P from the paper feed unit 2) to be delayed is sometimes observed due to the properties of the surface of the paper P, abrasion or sullying of the paper feed rotating body, or the like. In view whereat the paper feed rotating body starts rotating in subsequent paper feeding at a timing that is expedited in comparison to the earlier paper feeding when the conveyance time is longer than the reference time. This makes it possible to expedite the timing for starting the rotation of the paper feed rotating body, and to maintain the print speed at the reference speed.

The paper feed rotating body (the paper feed roller 22) starts rotation after the pause time has elapsed since the arrival of the paper P was detected by the detecting body (the resist sensor 4) or since the resist unit (the resist roller pair 5) started conveying the paper P, and, by causing the pause time to be shorter than that of the earlier print feeding, starts rotating at a timing that is expedited in comparison to that of the earlier paper feeding. A timing for when the rotation of the paper feed rotating body (the paper feed roller 22) should be started, so that the print speed is stably at the reference speed (the speed given in the specifications), is thereby adopted.

The image-forming apparatus (the printer 100) includes the transfer unit for transferring the toner image formed by the image formation unit 6 onto the paper P being conveyed, and the fixing unit 7a for affixing onto the paper P the toner image having been transferred by the transfer unit. This prevents poor transfer or poor affixation, caused by a persistent state where the print speed is faster, from taking place, because the print speed is held at the speed given in the specifications (the rate of paper per minute as given in the specifications). As such, it is possible to provide an image-forming apparatus having high image quality.

The image-forming apparatus (the printer 100) includes the memory for storing the data indicative of the pause time, and the memory resets the data indicative of the pause time to the predetermined reference pause time when predetermined conditions are fulfilled. This makes it possible to avoid continuing to make adjustments for causing the timing for starting the rotation of the paper feed roller 22 to deviate from the reference despite the fact that there has been a change in the status of the paper, such as when the paper is set so as to be correct.

The present disclosure can also be considered to be a method for controlling an image-forming apparatus.

The description shall now relate to other embodiments. In the embodiment described above, the time from the start of rotation of the paper feed roller 22 to when the resist sensor 4 detects the arrival of the paper was measured. However, the detecting body is not limited to being the resist sensor 4. For example, when a sensor for detecting the arrival of the paper exists upstream of the resist sensor 4 in the paper conveyance direction, the time from the start of rotation of the paper feed roller 22 to when the sensor detects the arrival of the paper may be measured to adjust the timing for the start of rotation of the paper feed roller.

The foregoing description was based on embodiments of the present disclosure, but the scope of the present disclosure is not limited thereto; implementation with a variety of modifications added in a scope not departing from the spirit of the disclosure is possible.

The present disclosure can be utilized for an image-forming apparatus that includes a resist roller pair issuing paper forth after having deflected same.

What is claimed is:

1. An image-forming apparatus, comprising:
an image formation unit for forming an image on paper;
a resist unit for conveying the paper toward the image formation unit and for stopping conveying the paper before the next paper arrives;
paper feed unit for accommodating a plurality of sheets of paper, the paper feed unit including a paper feed rotating body for rotating and thereby issuing the paper forth toward the resist unit and also for stopping before the next paper is supplied;
a detecting body for detecting the arrival of the paper, the detecting body being provided to a paper conveyance route between the resist unit and the paper feed rotating body; and
a clocking unit for clocking a conveyance time from the start of rotation of the paper feed rotating body to when the detecting body detects the arrival of the paper,
wherein the resist unit starts to convey paper when a predetermined deflection generation time has elapsed since the arrival of the paper was detected by the detecting body,
the paper feed rotating body starts to rotate in subsequent paper feeding at a timing that is delayed in comparison to earlier paper feeding when the conveyance time is shorter than a predetermined reference time.

2. The image-forming apparatus as set forth in claim 1,
wherein the paper feed rotating body is made to start rotating after a pause time has elapsed since the arrival of the paper was detected by the detecting body or since the resist unit started conveying the paper, and is made to start rotating at a timing that is delayed in comparison to earlier paper feeding by making the pause time longer than that of the earlier paper feeding.

3. The image-forming apparatus as set forth in claim 1,
wherein the paper feed rotating body starts to rotate at a timing that is delayed in comparison to the earlier paper feeding by an amount commensurate with the absolute value of the time difference between the reference time and any one conveyance time from among the conveyance times of a predetermined number of sheets, or with the absolute value of the time difference between the reference time and the average value of the conveyance times of a predetermined number of sheets.

4. The image-forming apparatus as set forth in claim 1,
wherein the paper feed rotating body starts to rotate at a timing that is delayed in comparison to the earlier paper feeding when any one conveyance time from among the conveyance times of a predetermined number of sheets or the average value of the conveyance times of a predetermined number of sheets is shorter than the reference time.

5. The image-forming apparatus as set forth in claim 1,
wherein the paper feed rotating body starts to rotate in subsequent paper feeding at a timing that is delayed in comparison to the earlier paper feeding when the conveyance times are shorter than the reference time with the predetermined number of sheets sent in a continuous fashion.

6. The image-forming apparatus as set forth in claim 1,
wherein the paper feed rotating body starts to rotate in subsequent paper feeding at a timing that is expedited in comparison to earlier paper feeding when the conveyance time is longer than the reference time.

7. The image-forming apparatus as set forth in claim 6,
wherein the paper feed rotating body is made to start rotating after a pause time has elapsed since the arrival of the paper was detected by the detecting body or since the resist unit started conveying the paper, and is made to start rotating at a timing that is expedited in comparison to earlier paper feeding by making the pause time shorter than that of the earlier paper feeding.

8. The image-forming apparatus as set forth in claim 1, comprising:
a transfer unit for transferring a toner image formed by the image formation unit onto the paper being conveyed, and
a fixing unit for fixing the toner image transferred by the transfer unit onto the paper.

9. The image-forming apparatus as set forth in claim 2, comprising:
a memory for storing data indicative of the pause time,
wherein the memory resets the data indicative of the pause time to a predetermined reference pause time when a predetermined condition is fulfilled.

10. A method for controlling an image-forming apparatus, the method comprising:
causing an image formation unit to form an image on paper;
causing a resist unit to convey the paper toward the image formation unit;
causing the resist unit to stop conveying paper before the next paper arrives;
accommodating a plurality of sheets of paper;
causing a paper feed rotating body to rotate to issue the accommodated paper forth toward the resist unit;
stopping the paper feed rotating body before the next paper is supplied;
detecting the arrival of the paper on a paper conveyance route between the resist unit and the paper feed rotating body;
clocking a conveyance time from the start of rotation of the paper feed rotating body to when the arrival of the paper is detected;
causing the resist unit to start conveying paper when a predetermined deflection generation time has elapsed since the arrival of the paper was detected; and
causing the paper feed rotating body to start rotating in subsequent paper feeding at a timing that is delayed in comparison to earlier paper feeding when the conveyance time is shorter than a predetermined reference time.

11. The method for controlling an image-forming apparatus as set forth in claim 10, further comprising:
the rotation of the paper feed rotating body being started after a pause time has elapsed since the arrival of the paper was detected by the detecting body or since the resist unit started conveying paper, and
the pause time being made longer than that of the earlier paper feeding, thereby causing the rotation of the paper feed rotating body to start rotating at a timing that is delayed in comparison to the earlier paper feeding.

12. The method for controlling an image-forming apparatus as set forth in claim 10, further comprising:
the rotation of the paper feed rotating body being started at a timing that is delayed in comparison to the earlier paper feeding by an amount commensurate with the absolute value of the time difference between the reference time and any one conveyance time from among the conveyance times of a predetermined number of sheets, or with the absolute value of the time difference between the reference value and the average value of the conveyance times of a predetermined number of sheets.

13. The method for controlling an image-forming apparatus as set forth in claim 10, further comprising:
the rotation of the paper feed rotating body being started at a timing that is delayed in comparison to earlier paper feeding when any one conveyance time from among the conveyance times of a predetermined number of sheets or the average value of the conveyance times of a predetermined number of sheets is shorter than the reference time.

14. The method for controlling an image-forming apparatus as set forth in claim 10, further comprising:
the rotation of the paper feed rotating body being started in subsequent paper feeding at a timing that is delayed in comparison to earlier paper feeding when the conveyance time is shorter than the reference time with the predetermined number of sheets sent in a continuous fashion.

15. The method for controlling an image-forming apparatus as set forth in claim 10, further comprising:
the rotation of the paper feed rotating body being started in subsequent paper feeding at a timing that is expedited in comparison to earlier paper feeding when the conveyance time is longer than the reference time.

16. The method for controlling an image-forming apparatus as set forth in claim 15, further comprising:
the rotation of the paper feed rotating body being started after a pause time has elapsed since the arrival of the paper was detected by the detecting body or since the resist unit started conveying paper, and
the pause time being made shorter than that of the earlier paper feeding, thereby causing the rotation of the paper feed rotating body to start rotating at a timing that is expedited in comparison to the earlier paper feeding.

17. The method for controlling an image-forming apparatus as set forth in claim 10, further comprising:
a toner image formed by the image formation unit being transferred onto the paper being conveyed, and
the transferred toner image being fixed onto the paper.

18. The method for controlling an image-forming apparatus as set forth in claim 11, further comprising:
data indicative of the pause time being stored, and
the data indicative of the pause time being reset to a predetermined reference pause time when a predetermined condition is fulfilled.
